(19) United States
(12) Patent Application Publication
(10) Pub. No.: US 2010/0034586 A1
(43) Pub. Date: Feb. 11, 2010

(54) Asphalt rejuvenation

(76) Inventors: Helen K. Bailey, Kirkby in Ashfield (GB); Paul Phillips, Brailsford (GB)

Correspondence Address: DLA PIPER LLP (US);ATTN: PATENT GROUP, P.O. Box 2758, Reston, VA, 20195, US

(21) Appl. No.: 12/461,234

(22) Filed: Aug. 5, 2009

(30) Foreign Application Priority Data
Aug. 5, 2008 (GB) 0814304.2

(51) Int. Cl. E01C 7/36; C11C 3/00; B05D 5/00

(52) U.S. Cl. 404/75; 106/504; 427/138

(57) ABSTRACT

A rejuvenating agent suitable for the rejuvenation of asphalt is disclosed, wherein said rejuvenating agent comprises one or more plant derived oils. The rejuvenating agent can also be used to alter the properties of a virgin (unaged) asphalt mix as well as for the rejuvenation of an aged asphalt.

### CROSS REFERENCE TO RELATED APPLICATIONS

This application claims priority under 35 U.S.C. § 119 to G.B. patent application no. 0814304.2, filed Aug. 5, 2008 and entitled “Asphalt Rejuvenation,” the entire contents of which are hereby incorporated by reference herein.

### FIELD

The invention relates to the rejuvenation of asphalt by the addition of rejuvenating agents derived from plant origin. Addition of such rejuvenating agents will result in softening of the aged binder and enhancing the flexibility of the mix.

### BACKGROUND

### 1. Bitumen/Vegetable Oil Blending:

It is well known that vegetable oils are excellent fluxes for all bituminous substances and can be used almost indiscriminately for softening asphaltic materials without adversely affecting their weather-resisting qualities or having a detrimental affect on the resulting mixture. Vegetable oils have been used in manufacturing certain bituminous lacquers, varnishes and japans, rubber substitutes, coating compositions for high-grade prepared roofings, electrical insulating compounds, and impregnating compounds. The addition of a small amount of vegetable oil to the bitumen during hot mix asphalt production is a technique that some contractors employ to mask the pungent smells of certain bitumens and to improve the rheological properties of bitumen.

Existing products include Bioflux™ from Shell, a vegetable oil based binder, for use in ‘hot mix asphalt’ and ‘hot surface dressing’ applications. It would be desirable to develop a technique that allowed control of the bitumen mixture properties by modification of the viscosity of the binder, hence giving a range of performance grades as desired. Therefore there is a need for new bitumen/vegetable oil blending technology that gives both this control of the bitumen mixture properties by modification of the viscosity of the binder and, by the use of vegetable oil derivatives (including waste cooking oils), to produce a ‘greener’ binder.

It was decided to conduct this preliminary investigation to explore the advantages or otherwise of blending known quantities of vegetable oil with penetration grade bitumen and the resultant effects on binder rheology. Asphalt samples were subsequently produced using these bitumen/oil blends and selected volumetric and mechanical properties of the resultant asphalt mixtures were investigated.

### 2. Rejuvenation of Asphalt Mixtures Using Vegetable Oils

Atmospheric exposure causes asphalts to gradually age due to weathering and oxidation. The increase in rigidity of the asphalt results in negative consequences with respect to flexural capacity (fatigue cracking) and thermal response (thermal cracking). Therefore, the timely and efficient maintenance of asphalts is crucial. The addition of rejuvenating agents in small quantities can bring an asphalt back to life through softening of the binder and restoring flexibility of the mix.

WO2008/006208 discloses a process for the rejuvenation of asphalt road surfaces. An asphalt-paved road surface is rejuvenated in a multi-stage recycling process. The first process stage involves grinding, to a selected depth and width, a first strip portion of the surface and transporting it away from the site. The second process stage involves heating and grinding, to a selected temperature and depth, the upper layer of a second strip portion and moving it to the first strip portion to expose a lower layer. The third process stage involves heating and grinding, to a selected temperature and depth, the exposed lower layer of the second strip portion and moving it to the first strip portion. New asphalt is then added to rejuvenate the recycled asphalt and to maintain the grade elevation. The mixture is then placed back on the road surface using conventional means.

It is usually required that the rejuvenating agent will soften the binder in the reclaimed asphalt to the preferred levels for a new mix, and that the rejuvenated binder will have physical properties meeting the local specifications for the new asphalt mixture. The ability of the rejuvenating agent to do this depends on the viscosity and the quantity added to the aged asphalt mixture. There is a need for a rejuvenating agent that is flexible in its manner of use, enables the properties of the rejuvenated asphalt to be restored as required across a wide spread of specifications and also, ideally, the rejuvenating agent should also have green, environmentally friendly properties, i.e. it is made in whole or in part from a recycled material.

### BRIEF DESCRIPTION OF THE DRAWINGS

FIG. 1 illustrates a Bitumen Test Data Chart for various bitumen/oil blends.

FIG. 2 illustrates rheological behavior of virgin and oil blended bitumen following a standard oven ageing protocol.

FIG. 3 illustrates the fatigue performance of asphalt mixtures composed of virgin and oil blended bitumen.

FIG. 4 illustrates the wheel tracking (permanent deformation) response of asphalt slabs composed of virgin bitumen, bitumen and vegetable oil blend, and bitumen and waste oil blend.

FIG. 5 illustrates the increase in stiffness of asphalt mix compacted cores with increasing ageing time.

### DETAILED DESCRIPTION

To investigate the use of a plant derived oil as a rejuvenator for aged asphalt mixtures, the loose asphalt mixtures were oven aged for various durations prior to compaction to produce a range of stiffness values (control mixes). A further five mixes were also aged for the maximum duration before vegetable oil was added to rejuvenate the mix (rejuvenated mixes). Mixtures in this experiment used the same grading and 40/60 penetration grade binder, and were compacted using a roller compactor to produce slabs and test specimens were cored. Density, air voids, stiffness and fatigue were key properties measured prior to recovering the binder for each aged set of specimens.

In a first aspect, there is provided a rejuvenating agent suitable for the rejuvenation of asphalt, wherein said rejuvenating agent comprises one or more plant derived oils.

In the first aspect, it is shown that the addition of a rejuvenating agent can be used for the rejuvenation of an aged asphalt by softening the aged binder and restoring flexibility. The rejuvenating agent can also be used to alter the properties of a virgin (unaged) asphalt mix.

Preferably, the plant derived oils for use in the first aspect are vegetable oils. More preferably, the plant derived oils for use in the first aspect are virgin plant oils (e.g. vegetable oils) or waste plant oils. Yet more preferably, they are waste plant oils and most preferably they are waste vegetable oils.

Virgin plant and vegetable oils are those obtained directly from the plants in question and which have not yet been used. Waste plant and vegetable oils are ones that have been used and would often be disposed of in an environmentally unfriendly manner, e.g. waste cooking oil. The amount of plant derived oil required to rejuvenate an aged asphalt mix is generally in the range from 2-20% oil by mass of bitumen. Preferably the amount of plant derived oil required is in the range from 3-13% oil by mass of bitumen. Most preferably the amount of plant derived oil required is in the range from 4-12% oil by mass of bitumen.

In a second aspect, there is provided an ex situ method for the rejuvenation of asphalt, said method comprising:

(a) planing an aged asphalted surface and transporting the separated surface to an asphalt plant;

(b) determining the composition and characteristics required for the rejuvenated asphalt;

(c) heating the surface removed from the asphalted surface through a hot mix drum;

(d) adding an asphalt rejuvenator into the mixer at the level calculated in (b) to provide the desired characteristics of the rejuvenated asphalt, and

(e) transporting the rejuvenated mix back to the planed surface from which the aged asphalt was removed, laying it on said surface and compacting it to give the desired rejuvenated asphalt surface, wherein said asphalt rejuvenator is a plant derived oil.

Preferably the said plant derived oil is a semi drying or non drying oil, exemplified in Table 1 below.

TABLE 1
Iodine and Linolenic Acid values for semi-drying and non-drying oils

| Oil | Iodine value | Linolenic Acid value |
|---|---|---|
| Soybean | 103-152 | 2-9 |
| Sunflower | 120-136 | — |
| Rapeseed (Canola) | 110-126 | 6-14 |
| Corn | 118-128 | 0.1-2 |
| Peanut | 84-100 | <0.1 |
| Olive | 80-88 | <0.9 |
| Coconut | 7.5-10.5 | — |
| Palm Kernal | 16.2-19.2 | — |

Preferably the plant derived oil is a vegetable oil, and more preferably a waste vegetable oil. Examples include waste sesame oil, waste sunflower oil, waste soybean oil, waste corn oil, waste palm oil or waste peanut oil.

The surface removed from the asphalted surface is heated to a temperature in the range from 40-200° C. in the hot mix drum. Preferably, the asphalted surface is heated to a temperature in the range from 100-160° C. The binder is heated until softened.

The amount of plant derived oil by mass of bitumen added is between 3-7%. Preferably 3% plant derived oil by mass of bitumen is added.

In a third aspect, there is provided an in situ method for the rejuvenation of asphalt, said method comprising:
(a) planing the surface to be rejuvenated;
(b) adding the asphalt rejuvenator to the planed material; and
(c) adding the rejuvenated material back and compacting it, wherein said asphalt rejuvenator is a plant derived oil.

The amount of plant derived oil by mass of bitumen added is from 3-11%. Preferably from 9-11% plant derived oil by mass of bitumen is added.

Prior to planing, the surface of the asphalt may be heated directly or indirectly. Direct heating techniques include the use of heating lamps, infra red, hot air/gas, super heated steam (reduced water content). Indirect methods of heating include microwave heating. These heating methods may be used in combination or on their own.

Alternatively, the surface to be rejuvenated may be planed out cold and then heated within the drum of the recycling machine where the rejuvenator may also be sprayed. Heating may also be carried out using a second machine which scoops up and heats the milled material agitates.

Preferably the planed out surface is heated within a machine for performing rejuvenating step (b) or a separate second machine to a temperature in the range from 40-200° C. Most preferably, the planed out surface is heated to a temperature in the range from 100-160° C.

Preferably the said plant derived oil is a semi drying or non drying oil. Preferably the plant derived oil is a vegetable oil, and more preferably a waste vegetable oil. Examples include waste sesame oil, waste sunflower oil, waste soybean oil, waste corn oil, waste palm oil or waste peanut oil.

In a fourth aspect, there is provided a method for modifying the viscosity of a bituminous binder, said method comprising modifying the viscosity of said binder using at least one plant derived oil, wherein the identity and quantity of the plant derived oil employed is calculated to achieve the desired viscosity.

Preferably the said plant derived oil is a semi drying or non drying oil. Preferably the plant derived oil is a vegetable oil, and more preferably a waste vegetable oil. Examples include waste sesame oil, waste sunflower oil, waste soybean oil, waste corn oil, waste palm oil or waste peanut oil.

In some embodiments, the operation (quality and quantity) is under the control of the contractor rather than the binder supplier, allowing the contractor greater flexibility and freedom. It also gives rise to a wider range of choice that includes semi drying or non drying plant derived oils.

Also, by virtue of using waste plant oil derivatives (including waste cooking oils) an ‘environmentally friendly’ binder is provided.

Efficiency is also increased though the reduction of the required number of binder tanks at the asphalt plant. In addition, the tanks containing vegetable oil will require less heating and can generally be stored without the need for heat. Plant derived oil as a bitumen replacement also offers reduced dependency on landfill for disposal, reduction in embodied carbon dioxide of the resultant asphalt mixture, less reliance on expensive imported hydrocarbons, and is also easier to handle during manufacturing.

Accordingly, straight run bitumens are extended using plant oils, including virgin plant oils and/or waste plant oil derivatives.

The present invention may be further understood by reference to the following non-limiting examples.

Bio-Blending Examples:

A blending technique that allows the asphalt producer to control the properties of the mixture. This is achieved though modification of the viscosity of the binder, resulting in a range of mixture types (performance grades) being obtained (i.e. the blending of a conventional penetration grade bitumen with oil to modify the binder grade). This is advantageous when only a limited number of binder tanks are available at the asphalt plant.

Technical knowledge is already in place to achieve the desired viscosity to a very high degree of accuracy. Laboratory work has shown the blended binders are indistinguishable from the straight run/unmodified binders in terms of rheology, mechanical and volumetric mix properties, mixture aging and water damage performance.

In an initial experiment, a 40/60 penetration grade bitumen was blended with virgin vegetable oil to produce a range of bitumen/oil blends which were then used to manufacture asphalt specimens. Groundnut cooking oil was arbitrarily selected and used in this blending experiment. Table 2 shows the effect of blending virgin oil with bitumen on penetration, softening point and viscosity.

TABLE 2
Effect of blending virgin oil with bitumen on penetration, softening point and viscosity

| Oil Content | Penetration | Softening | Viscosity (Pa · s) at: | | | Temperature at |
|---|---|---|---|---|---|---|
| (%) | (dmm) | Point (° C.) | 120° C. | 150° C. | 180° C. | 0.2 Pa · s (° C.) |
| 0 | 56 | 50.4 | 1.074 | 0.231 | 0.074 | 160* |
| 2 | 89 | 46.6 | 0.844 | 0.200 | 0.064 | 156 |
| 4 | 121 | 44.3 | 0.723 | 0.172 | 0.06 | 152 |
| 6 | 155 | 41.1 | 0.607 | 0.151 | 0.053 | 149 |
| 8 | 222 | 37.2 | 0.504 | 0.131 | 0.046 | 146 |
| 10 | 285 | 33.7 | 0.429 | 0.117 | 0.044 | 143 |

In the late sixties Heukelom developed a system that enables penetration, softening point, Frass breaking point and viscosity data to be described as a function of temperature on one chart, known as the Bitumen Test Data Chart (BTDC).

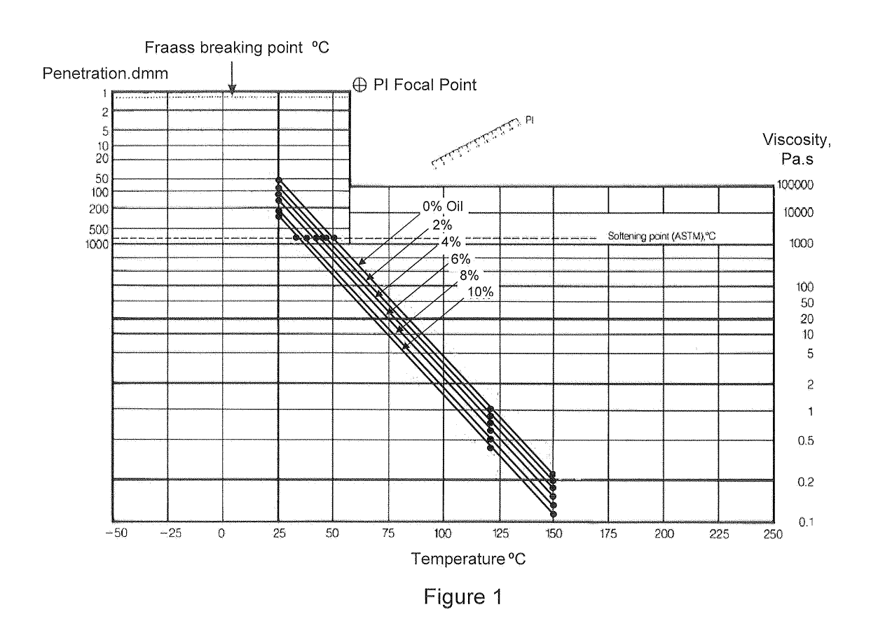

FIG. 1 shows a BTDC showing the relationships between penetration, softening point and viscosity for all the bitumen/oil blends investigated. The results prove that the chart enables the temperature/viscosity characteristics of a penetration grade bitumen to be determined over a wide range of temperatures from only the penetration and softening point of the bitumen. The chart thus provides a means of selecting the appropriate operating temperatures and viscosity requirements for asphalt mixture, manufacture and application.

According to BS EN 12697-35:2004, the reference mixing temperature of 40/60 penetration grade bitumen shall be 155° C. The target mixing temperature for this bitumen grade shall be selected so that the mixture shall be 20° C. greater than the reference temperature. In this investigation, a mixing temperature of 160° C. was selected, the point at which the bitumen achieves a viscosity of just under 0.2 Pa·s. Based on this viscosity value, using the BTDC, it was possible to select the optimum mixing temperatures for all the other bitumen/oil blends as shown in the right hand column of Table 2 above.

In order to validate laboratory testing and comply with the framework for penetration grade bitumens, various blends were prepared in the laboratory using used vegetable oils and tested in accordance with the requirements of BS EN 12591 (British Standards Institution, ‘Bitumen and bituminous binders: Specifications for paving grade bitumens’ BS EN 12591: 2000).

Table 3 shows the specifications for paving grade bitumens for grades from 20×0.1 mm to 330×0.1 mm penetration.

Table 4 shows the results of blended binders tested to BS 12591.

TABLE 3
Specifications for paving grade bitumens for grades from 20 × 0.1 mm to 330 × 0.1 mm penetration.

| | | Test | Grade designation | | | | | | | | |
|---|---|---|---|---|---|---|---|---|---|---|---|
| | Unit | Method | 20/30 | 30/45 | 35/50 | 40/60 | 50/70 | 70/100 | 100/150 | 160/220 | 250/330 |
| Penetration at 25° C. | ×0.1 mm | EN 1426 | 20-30 | 30-45 | 35-50 | 40-60 | 50-70 | 70-100 | 100-150 | 160-220 | 250-330 |
| Softening Point | ° C. | EN 1427 | 55-63 | 52-60 | 50-58 | 48-56 | 46-54 | 43-51 | 39-47 | 35-43 | 30-38 |
| Resistance to hardening, | | EN 12607-1 or | | | | | | | | | |
| at 163° C. (a) | | EN 12607-3 | | | | | | | | | |
| change of mass, | % | | 0.5 | 0.5 | 0.5 | 0.5 | 0.5 | 0.8 | 0.8 | 1.0 | 1.0 |
| maximum± | | | | | | | | | | | |
| retained penetration, | % | | 55 | 53 | 53 | 50 | 50 | 46 | 43 | 37 | 35 |
| minimum | | | | | | | | | | | |
| softening point after | ° C. | EN 1427 | 57 | 54 | 52 | 49 | 48 | 45 | 41 | 37 | 32 |
| hardening, minimum | | | | | | | | | | | |
| Flash Point | ° C. | EN 22592 (b) | 240 | 240 | 240 | 230 | 230 | 230 | 230 | 220 | 220 |
| Solubility, minimum | % (m/m) | EN 12592 | 99.0 | 99.0 | 99.0 | 99.0 | 99.0 | 99.0 | 99.0 | 99.0 | 99.0 |

TABLE 4
Results of blended binders tested to BS12591.

| | | Test | Percentage oil added to 40/60 pen | | | | | | | |
|---|---|---|---|---|---|---|---|---|---|---|
| | Unit | Method | 0 | 2 | 4 | 5 | 6 | 7 | 8 | 10 |
| Penetration at 25° C. | ×0.1 mm | EN 1426 | 40-60 | 74 | 110 | 134 | 149 | 184 | 213 | 242 |
| Softening Point | ° C. | EN 1427 | 48-56 | 50.0 | 46.6 | 42.6 | 44.0 | 41.8 | 38.4 | 38.0 |
| Resistance to hardening, | | EN 12607-1 or | | | | | | | | |
| at 163° C. (a) | | EN 12607-3 | | | | | | | | |
| Change of mass, | % | | 0.5 | 0.03 | −0.01 | −0.02 | −0.04 | 0.0002 | −0.07 | 0.03 |
| maximum± | | | | | | | | | | |
| Retained penetration, | % | | 50 | 61 | 59 | 57 | 55 | 54 | 53 | 53 |
| minimum | | | | | | | | | | |
| Softening point after | ° C. | EN 1427 | 49 | 46.6 | 52.6 | 50.6 | 49.8 | 48.4 | 46.2 | 45.2 |
| hardening, minimum | | | | | | | | | | |
| Flash Point | ° C. | EN 22592 (b) | 230 | >300 | >300 | >300 | >300 | >300 | >300 | >300 |
| Solubility, minimum | % (m/m) | EN 12592 | 99.0 | 99.6 | 99.4 | 99.5 | 99.4 | 99.4 | 99.3 | 99.3 |

| | | | | | | | | |
|---|---|---|---|---|---|---|---|---|
| Equivalent compliant grade | — | 70/100 | 100/150 | 100/150 | 100/150 | 160/220 | 160/220 | — |

Early trials whereby various percentages of oil were blended with one grade of bitumen proved that vegetable oils were very compatible with straight run bitumens, that blending was a very simple process and that the oil does not affect the temperature susceptibility of the bitumens in any adverse way. The results demonstrate that it is possible to modify a standard penetration grade bitumen to any other softer grade by carefully blending with vegetable oil, thus allowing the designer to customise a binder to any target viscosity.

A mixing trial was carried out to examine the properties of asphalt containing UVO in order to determine its suitability in the field. A control mix using 160/220 penetration grade binder was compared to a mixture using 40/60 penetration grade binder blended with 7% UVO (as determined from Table 4). The mixing trial was also used to assess the best method of getting the UVO into the mixture and also determine whether any additional mixing time is required to improve the blending/diffusion of the UVO with the bitumen. A summary of the mixtures can be found listed below:
1. Mix 1: Control mix using 160/220 pen (standard mixture)
2. Mix 2: 40/60 penetration+7% UVO, oil in the kettle prior to the bitumen, standard mixing time.
3. Mix 3: 40/60 penetration+7% UVO, oil in low melt bag straight onto hot aggregates then bitumen added, standard mixing time.
4. Mix 4: 40/60 penetration+7% UVO, oil in the kettle prior to the bitumen, mixing time was doubled.

Table 5 shows that the properties of the blended mixtures were indistinguishable from the properties of the control mixture.

TABLE 5
Summary of average results obtained from lab prepared samples

| | Mixture Reference | | | |
|---|---|---|---|---|
| Property | 1 | 2 | 3 | 4 |
| Maximum density, kg/m³ | 2583 | 2576 | 2573 | 2557 |
| Bulk density, kg/m³ | 2317 | 2356 | 2312 | 2369 |
| (Proc. C-sealed) | | | | |
| Air void content, % | 10.3 | 8.5 | 10.2 | 7.4 |
| Stiffness, MPa | 670 | 674 | 433 | 760 |
| Water Sensitivity | 0.88 | 0.92 | 0.71 | 0.87 |
| (Stiffness Ratio) | | | | |
| Penetration (dmm) | 122 | 169 | 80 | 76 |
| Softening Point (° C.) | 42.3 | 40.1 | 50.4 | 48 |

To prove whether or not an oil blended bitumen of a known grade would be indistinguishable from and have equal performance to an equivalent straight run bitumen, it was decided to convert a 10/20 penetration straight run bitumen into a 40/60 penetration grade by blending with vegetable oil. 10/20 straight run bitumen was chosen because it is currently the hardest grade of bitumen available commercially. The amount of blended oil was carefully selected so that the blended bitumen acquires rheological characteristics identical to those of the virgin bitumen. Table 6 shows the effect of blending of UVO with 10/20 penetration bitumen.

TABLE 6
Effect of blending of UVO with 10/20 penetration bitumen

| | Penetration (dmm) |
|---|---|
| % UVO added | at 25° C. |
| 0 | 15 |
| 5 | 37 |
| 10 | 89 |
| 15 | 207 |
| 20 | >300 |
| 25 | >300 |
| 30 | >300 |

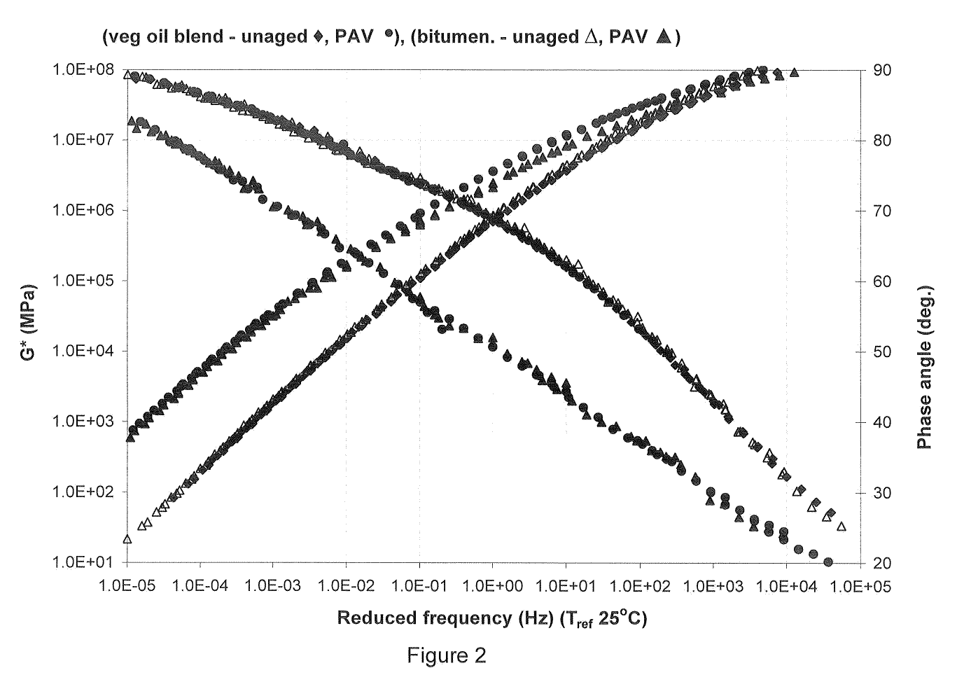

The results shown in FIG. 2 indicate that both 40/60 penetration grade bitumen and 10/20 penetration straight run bitumen when blended with UVO have identical rheological behavior even following a standard oven ageing protocol.

More fundamental rheological testing was also undertaken by means of Dynamic Shear Rheometry (DSR) conducted within the region of Linear Visco-Elastic (LVE) response. DSRs apply oscillating shear stresses and strains to samples of bitumen sandwiched between parallel plates at different loading frequencies and temperatures. The DSR tests reported were performed under the following test conditions: controlled strain mode of loading, test temperatures ranging from 0 to 80° C. in 5° C. increments, 0.01 to 10 Hz test frequency, parallel plate geometries (8 mm diameter with 2 mm gap for low temperatures, and 25 mm diameter with 1 mm gap for high temperatures), strain amplitude kept within the LVE response (0.5 to 10%) depending on G* values. The rheological properties of the blends were measured in terms of complex (shear) modulus (stiffness) G*, and phase angle δ.

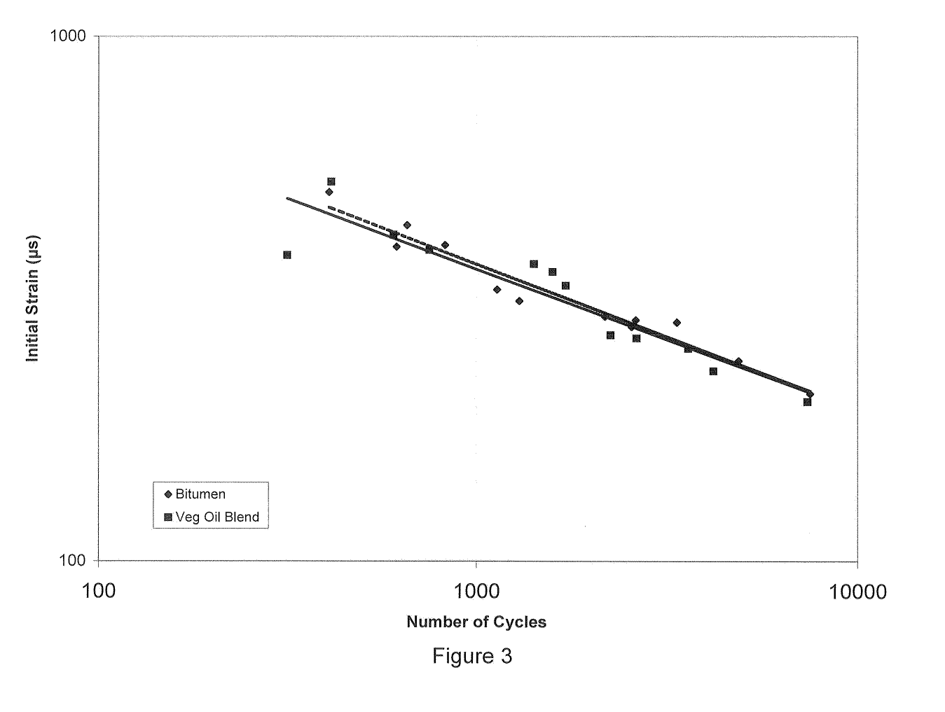

FIG. 3 shows the fatigue performance of asphalt mixtures composed of virgin and oil blended. The tests were carried out on asphalt samples having identical gradations, binder content and compaction level. The results indicate that it would not be possible to differentiate between the fatigue performance of asphalts composed of either binder type.

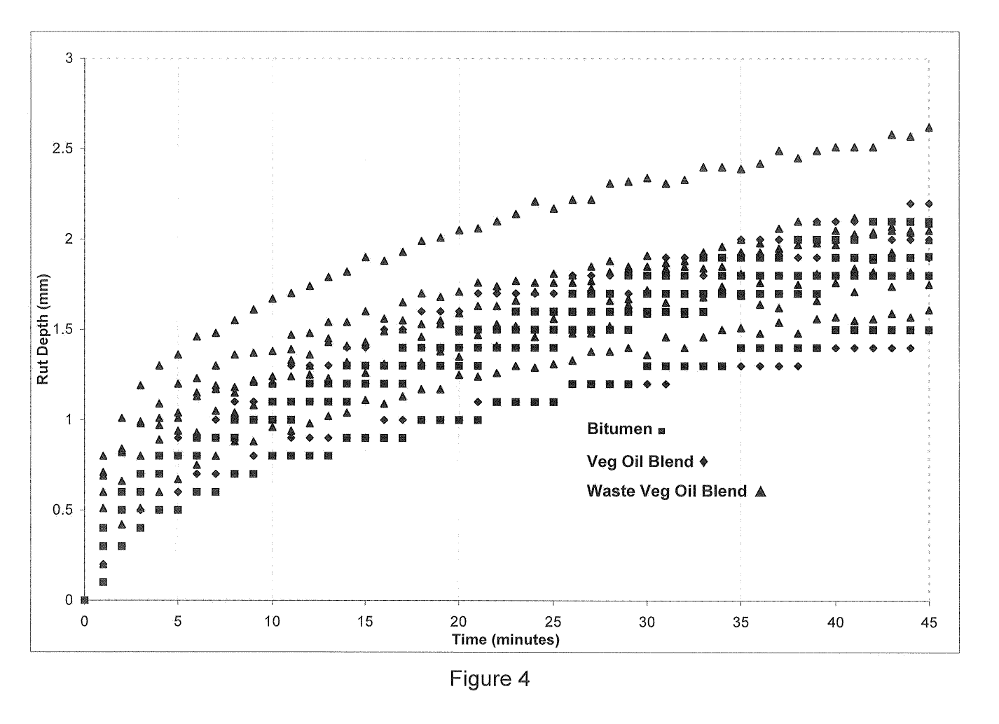

FIG. 4 illustrates the resistance to permanent deformation using a loaded wheel tracker at 60° C. FIG. 4 compares the wheel tracking (permanent deformation) response of asphalt slabs composed of virgin bitumen, bitumen and vegetable oil blend, and bitumen and waste oil blend. Slabs were compacted to the same compaction effort and all mixes had the same gradation and binder content, the only variable being the binder type.

To test the oven aging of mixtures, tests were carried out on asphalt samples having identical gradations, binder content and compaction level. Short-term oven aging (4 hours at the mixing temperature) is applied to the loose mix prior to compaction to simulate mixing at the plant and during laying, whereas long-term aging is applied to the compacted specimen. Long-term aging in this experiment was 5 days at 85° C. to simulate aging during pavement life.

Table 7 below compares the percent change in stiffness with oven aging on asphalt mixtures. The results indicate that it would not be possible to differentiate between the performance of asphalts composed of either binder type.

TABLE 7
Comparison of Percent Change in Stiffness
with Oven Aging on Asphalt mixtures

Percent Change in Stiffness

| Binder | STOA | LTOA (Inc. STOA) |
|---|---|---|
| Bitumen | +45 | +62 |
| Vegetable Oil Blend | +48 | +65 |

Short term oven aging (STOA)
Long term oven aging (LTOA)

The results proved that vegetable oils were very compatible with straight run bitumens, that blending was a very simple process and that the oil does not affect the temperature susceptibility of the bitumens in any adverse way. The results demonstrate that it is possible to modify a standard penetration grade bitumen to any other softer grade by carefully blending with vegetable oil, thus allowing the designer to customise a binder to any target viscosity or G* value.

### Rejuvenation Examples:

Work has been carried out to assess viability of using vegetable oils as rejuvenators.

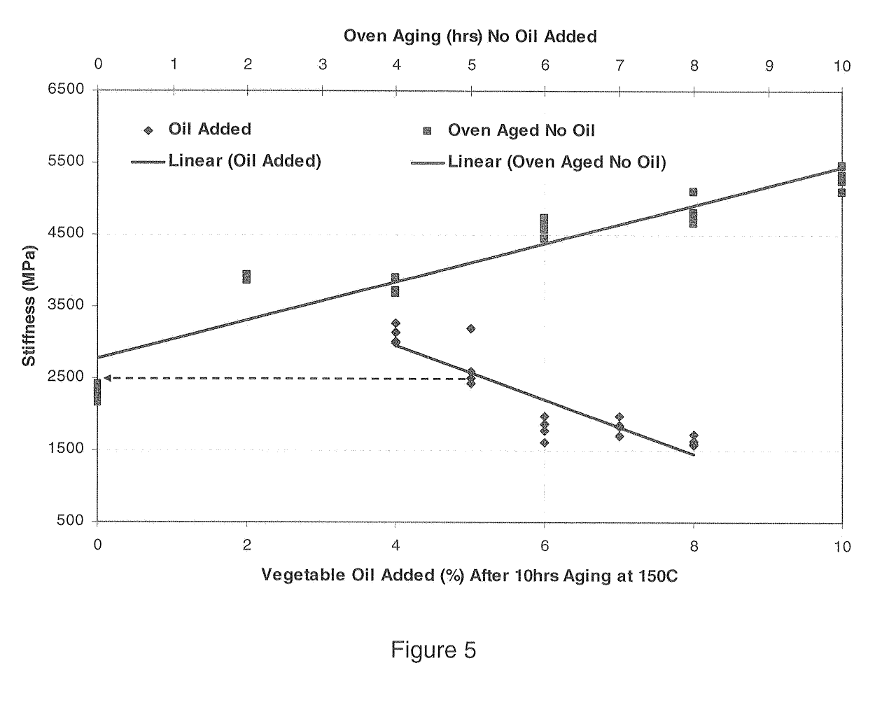

Following mixing with the binder, the loose asphalt mixes were spread in metallic trays and oven aged at 150° C. for a range of durations, namely; 2, 4, 6, 8 and 10 hrs prior to compaction. Using this technique, 5 mixes were thus produced at various stages/levels of ageing. The mixes were roller compacted and the slabs were cored and the specimens tested for volumetrics and stiffness (ITSM). The increase in stiffness of the compacted cores with increasing loose mix ageing time are shown in FIG. 5.

An additional set of 5 batches were produced and these were all aged in the loose state for 10 hours at 150° C. For these mixes, a known amount of groundnut oil was added to each batch and thoroughly mixed in with the asphalt (2 minutes at mixing temperature) prior to roller compaction. The amounts of oil added to the mixes were 4, 5, 6, 7 and 8% oil by mass of bitumen. The effect of adding oil on the aged loose mix is shown in FIG. 5.

The results show how effective vegetable oil can be as a rejuvenating agent. It can be seen from FIG. 5, that starting from a 10 hour oven aged mix, it is possible to rejuvenate that mix back to its original state by introducing approximately 5% vegetable oil during the hot mix recycling stage.

Ex situ Recycling Examples:

(a) Overall Procedure:
Milling the aged pavement and transport it to asphalt plant;
Heating the coated stones through a hot mix drum;
Blending the rejuvenating agent into a mixer;
Transporting the hot rejuvenated mix to the site, to be laid and compacted.

(b) Mix Design:
Taking cores from pavement or stockpiled planings;
Determining the composition and characteristics of aged mixture and binder through rheological analysis;
Using rheological analysis of aged binder and known target viscosity to determine how much rejuvenator is required to bring it back to the target; via well established blending charts and/or equations to determine the quantity of rejuvenator to be added;
Adding small amounts of mineral or recycled aggregate to adjust the final gradation if necessary;
Further testing to confirm mix design.
   In situ Recycling Examples:
Mix design and material selection as per Example 1 (Ex Situ Recycling)
Overall Site Procedure (passes of planning equipment to guarantee full dispersion of rejuvenator essential):
   (a) Planing the surface to be rejuvenated;
   (b) Adding the rejuvenator to the planed material followed by thorough mixing;
   (c) Immediately compacting the rejuvenated material.

Prior to planing, the surface of the asphalt may be heated directly or indirectly. Direct heating techniques include the use of heating lamps, infra red, hot air/gas, super heated steam (reduced water content). Indirect methods of heating include microwave heating. These heating methods may be used in combination or on their own.

Alternatively, the surface to be rejuvenated may planed out cold and is subsequently heated within the drum of the recycling machine where the rejuvenator may also be sprayed. Heating may also be carried out using a second machine which scoops up and heats the milled material agitates.

In order to validate the initial theory of oil rejuvenation and substitute used vegetable oils (UVO) for virgin oil, material was sampled from the recycled asphalt planings (RAP) stockpile and sent for compositional analysis, recovered penetration and softening point. These results are shown in Table 8 below.

TABLE 8
Recovered binder results from RAP stockpile

| Date of | Binder Content | Penetration | Softening Point |
|---|---|---|---|
| Sampling | (%) | (dmm) | (° C.) |
| January 2009 | 4.3 | 31 | 58.5 |
| January 2009 | 4.4 | 21 | 58.8 |
| January 2009 | 4.4 | 19 | 58.3 |
| January 2009 | 5.9 | 30 | 54.7 |
| March 2009 | 5.0 | 19 | 61.8 |

The hot mix recycler utilises 100% RAP, 160/220 penetration binder is added subject to visual inspection, (typically 20 kg per 5 t batch). The recycler typically operates at a temperature in the range 40-200° C., producing a 5 t batch every 20 minutes.

Based on experience gained through early laboratory work described above and recovered binder results obtained from the compositional analysis during March, it was possible to determine the starting value of used vegetable oil to be added. The following mixtures were produced in the laboratory for evaluation;
1. Mix 1: Control mix: 100% RAP, no added binder
2. Mix 2: 100% RAP, 1% added bitumen by mass of binder
3. Mix 3: 100% RAP, 3% added UVO
4. Mix 4: 100% RAP, 5% added UVO
5. Mix 5: 100% RAP, 7% UVO

### Lab and Field Trials

Laboratory specimens of each mixture were manufactured from bulk samples. Maximum densities were determined as per EN 12697-5 (British Standards Institution, BS EN 12697-5: 2002. Bituminous mixtures—Tests methods for hot mix asphalt. Determination of the maximum density), bulk density and voids as per EN 12697-6 (British Standards Institution, BS EN 12697-6: 2002. Bituminous mixtures—Tests methods for hot mix asphalt. Determination of bulk density of bituminous specimens), Procedure A—unsealed, and EN 12697-8 (British Standards Institution, BS EN 12697-8: 2002. Bituminous mixtures—Tests methods for hot mix asphalt. Determination of void characteristics of bituminous specimens) and stiffness values as per EN 12697-26 (British Standards Institution, BS EN 12697-26: 2004. Bituminous mixtures—Tests methods for hot mix asphalt. Part 26: Stiffness, Annex C. Test applying indirect tension to cylindrical specimens (IT-CY)). Average values for lab and field results are presented in Table 10 and Table 12 respectively. Individual results are given in Table 9.

TABLE 9
Mechanical properties for the lab work

| | | Max | Procedure A (Unsealed) | | Adjusted |
|---|---|---|---|---|---|
| Mix | Gyratory | Density | Bulk Density | Air Voids | Stiffness |
| Reference | Ref | (kg/m³) | (kg/m³) | (%) | (MPa) |
| Mix 1 | 794 | 2591 | — | — | 4673 |
| Control | 795 | 2591 | 2454 | 5.3 | 7275 |
| RAP | 796 | 2591 | 2454 | 5.3 | 7704 |
| Mix 2 | 797 | 2517 | 2475 | 1.6 | 7562 |
| 1% bitumen | 798 | 2517 | 2467 | 0.6 | 7920 |
| added | 799 | 2517 | 2459 | 2.2 | 8206 |
| Mix 3 | 800 | 2544 | 2461 | 3.2 | 8343 |
| 3% UVO | 801 | 2544 | 2494 | 1.9 | 9047 |
| added | 802 | 2544 | 2490 | 2.1 | 10127 |
| Mix 4 | 803 | 2474 | 2446 | 1.1 | 4496 |
| 5% UVO | 804 | 2474 | 2454 | 0.7 | 5280 |
| added | 805 | 2474 | 2453 | 0.8 | 5806 |
| Mix 5 | 806 | 2457 | 2421 | 1.4 | 3926 |
| 7% UVO | 807 | 2457 | 2418 | 1.6 | 4462 |
| added | 808 | 2457 | 2425 | 1.3 | 4228 |

Binder was also recovered from each mixture with penetration and softening point tests were performed in accordance with BS EN 1426: 2007 and BS EN 1427:2007 respectively. This was to determine whether or not the UVO had a rejuvenating effect on the binder. Results can be found in Table 11 and Table 13 respectively. They show that used vegetable oil can be used to rejuvenate aged asphalt mixtures, and have greatest effect when added to heated RAP.

TABLE 10
Summary of mechanical properties obtained
from lab produced mixtures

| | Average | Average | Average | Average |
|---|---|---|---|---|
| Mix | Maximum Density | Bulk Density | Air Voids | Stiffness |
| Reference | kg/m³ | kg/m³ | % | Mpa |
| 1 | 2591 | 2454 | 5.3 | 6551 |
| 2 | 2517 | 2467 | 2.0 | 7896 |
| 3 | 2544 | 2482 | 2.4 | 9172 |
| 4 | 2474 | 2451 | 0.9 | 5194 |
| 5 | 2457 | 2421 | 1.5 | 4205 |

TABLE 11
Summary of recovered binders

| Mix | Average Penetration | Average Softening Point |
|---|---|---|
| Reference | (dmm) | (° C.) |
| Mix 1 | 16 | 68.8 |
| Mix 2 | 18 | 68.8 |
| Mix 3 | 17 | 72.0 |
| Mix 4 | 19 | 75.2 |
| Mix 5 | 20 | 74.4 |

### Field Trial

Following evaluation of the lab work, a 3 t batch with 3% UVO added directly to the plant. Generally the material produced by the hot mix recycler is used in hand lay applications. As a result the batch was evaluated using conventional hand lay procedures. Batches with higher oil contents (9% and 11%) were produced and found to have good workability. A 5 tonnne batch using RAP only was produced as a control. Bulk samples of each were brought back to the laboratory for evaluation. The mixtures evaluated in the laboratory were:
1. Control mix: 100% RAP, no binder added (5 t batch)
2. Mix 1: 100% RAP, 3% UVO added at plant (3 t batch)
3. Mix 2: 100% RAP, 7% UVO added at plant (3 t batch)
4. Mix 3: 100% RAP, 7% UVO added in bucket of loading shovel (2 t batch)
5. Mix 4: 100% RAP, 9% UVO added in bucket of loading shovel (2 t batch)
6. Mix 5: 100% RAP, 11% UVO added in bucket of loading shovel (3 t batch)

Mixtures 1 and 2 were heated in the recycler to a temperature in the range between 40-200° C. and dry mixed for 5-25 minutes before the UVO was added. Mixtures 3, 4 and 5 had UVO added to cold RAP in the bucket of the loading shovel before being placed in the recycler.

TABLE 12
Summary of mechanical properties obtained
from field produced mixtures

| Mix | Maximum Density | Bulk Density | Air Voids | Stiffness |
|---|---|---|---|---|
| Reference | kg/m³ | kg/m³ | % | Mpa |
| Control Mix | 2527 | 2421 | 4.2 | 2527 |
| Mix 1 | 2535 | 2523 | 0.5 | 2535 |
| Mix 2 | 2510 | 2401 | 4.3 | 2510 |
| Mix 3 | 2495 | 2406 | 3.6 | 2495 |
| Mix 4 | 2502 | 2398 | 4.2 | 2502 |
| Mix 5 | 2503 | 2386 | 4.7 | 2503 |

TABLE 13
Summary of recovered binders

| Mix | Average Penetration | Average Softening Point |
|---|---|---|
| Reference | (dmm) | (° C.) |
| Control Mix | 36 | 60.8 |
| Mix 1 | 33 | 60.0 |
| Mix 2 | 93 | 47.0 |
| Mix 3 | 40 | 58.0 |
| Mix 4 | 59 | 53.6 |
| Mix 5 | 65 | 52.6 |

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Those of skill in this art may devise other such variations. Thus, the present inventions should be limited only by the claims as set forth below.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

We claim:

1. A rejuvenating agent suitable for the rejuvenation of asphalt comprising:
a plant derived oil.

2. A rejuvenating agent according to claim 1, wherein the plant derived oil is a virgin plant oil or a waste plant oil.

3. A rejuvenating agent according to claim 2, wherein said waste plant oil is a waste vegetable oil.

4. A method according to claim 1, wherein said plant derived oil is selected from waste sesame oil, waste sunflower oil, waste soybean oil, waste corn oil, waste palm oil and waste peanut oil.

5. A method according to claim 1, wherein the amount of the plant derived oil by mass of bitumen added to said asphalt is from 2-20%.

6. A method according to claim 5, wherein the amount of plant derived oil by mass of bitumen added to said asphalt is from 4-12%.

7. An ex situ method for the rejuvenation of asphalt, said method comprising:
(a) planing an aged asphalted surface and transporting the surface thus removed to an asphalt plant;
(b) determining the composition and characteristics required for the rejuvenated asphalt;
(c) heating the surface removed from the asphalted surface through a hot mix drum;
(d) adding an asphalt rejuvenator into said hot mix drum at the level calculated in (b) to provide the desired characteristics of the rejuvenated asphalt, and
(e) transporting the rejuvenated mix back to the planed surface from which the aged asphalt was removed, laying it on said surface and compacting it to give the desired rejuvenated asphalt surface, wherein said asphalt rejuvenator is a plant derived oil.

8. An ex situ method according to claim 7, wherein the surface removed from the asphalted surface is heated at a temperature in the range from 40-200° C.

9. An ex situ method according to claim 8, wherein the surface removed from the asphalted surface is heated to a temperature in the range from 100-160° C.

10. An ex situ method according to claim 7, wherein the amount of plant derived oil by mass of bitumen added is from 3-7%.

11. An ex situ method according to claim 10, wherein the amount of plant derived oil by mass of bitumen added is 3%.

12. An ex situ method according to claim 7, wherein said plant derived oil is preferably a waste cooking oil.

13. An ex situ method according to claim 12, wherein said plant derived oil is selected from waste sesame oil, waste sunflower oil, waste soybean oil, waste corn oil, waste palm oil and waste peanut oil.

14. An in situ method for the rejuvenation of asphalt, said method comprising:
(a) planing the surface to be rejuvenated;
(b) adding the asphalt rejuvenator to the planed material; and
(c) adding the rejuvenated material back to the surface from which it was planed and compacting it,
wherein said asphalt rejuvenator is a plant derived oil.

15. An in situ method according to claim 14, wherein the amount of plant derived oil by mass of bitumen added is from 3-11%.

16. An in situ method according to claim 15, wherein the amount of plant derived oil by mass of bitumen added is preferably from 9-11%.

17. An in situ method according to claims 14, wherein the surface to be rejuvenated may be directly or indirectly heated prior to planing.

18. An in situ method according to claim 17, wherein the surface is heated by means of a heating technique selected from the use of heating lamps, infra red, hot air/gas, super heated steam (reduced water content) or microwave heating.

19. An in situ method according to claim 18, wherein the surface is planed out cold and is subsequently heated within a machine for performing rejuvenating step (b) or a separate second machine.

20. A method according to claim 19, wherein the planed out surface is heated at a temperature in the range from 40-200° C. in a machine for performing rejuvenating step (b) or a separate second machine.

21. A method according to claim 20, wherein, the planed out surface is heated preferably to a temperature in the range from 100-160° C. in a machine for performing rejuvenating step (b) or a separate second machine.

22. A method for modifying the viscosity of a bituminous binder, said method comprising modifying the viscosity of said binder using at least one plant derived oil, wherein the identity and quantity of the plant derived oil employed is calculated to achieve the desired viscosity by first measuring the viscosity of the bituminous binder and then choosing the appropriate identity and quantity of plant derived oil to achieve the desired viscosity modification.

23. A method according to claim 22, wherein said bituminous binder and vegetable oil is a virgin mixture.

24. A method according to claim 22, wherein said plant derived oil is selected from waste sesame oil, waste sunflower oil, waste soybean oil, waste corn oil, waste palm oil and waste peanut oil.
